(19) United States
(12) Patent Application Publication
(10) Pub. No.: US 2021/0185175 A1
(43) Pub. Date: Jun. 17, 2021

(54) CALL TERMINAL, CALL SYSTEM, CONTROL METHOD OF CALL TERMINAL, AND NON-TRANSITORY RECORDING MEDIUM

(71) Applicant: SHARP KABUSHIKI KAISHA, Sakai City, Osaka (JP)

(72) Inventors: TAKEAKI SUENAGA, Sakai City, Osaka (JP); HISAO HATTORI, Sakai City, Osaka (JP); MAKOTO OTSU, Sakai City, Osaka (JP)

(21) Appl. No.: 17/263,540

(22) PCT Filed: Jul. 17, 2019
(86) PCT No.: PCT/JP2019/028142

§ 371 Date: Jan. 26, 2021

(30) Foreign Application Priority Data
Jul. 27, 2018 (JP) 2018-141664

(51) Int. Cl. H04M 3/56; H04S 7/00

(52) U.S. Cl. CPC H04M 3/568; H04S 7/305; H04S 7/302

(57) ABSTRACT

A call terminal includes: a reception unit configured to receive a voice signal of each of one or more call partners; a localization position determination unit configured to, in a case where one of the one or more call partners is added, determine a localization position corresponding to the voice signal of the added one of the one or more call partners not to overlap with a localization position corresponding to the voice signal of another one of the one or more call partners; and a voice output unit configured to output voice corresponding to each voice signal in manner that the voice is localized at the localization position determined by the localization position determination unit.

### TECHNICAL FIELD

The present invention relates to a call terminal, a call system, and a control method of a call terminal, in which a call is performed with multiple people. The present invention also relates to a call program for causing a computer to operate as the call terminal, and a recording medium recording such a call program.

The present application claims priority to Japanese Patent Application No. 2018-141664 filed in Japan on 27 Jul. 2018, of which contents are incorporated herein by reference.

### BACKGROUND ART

In recent years, as information terminals as typified by smartphones have become widespread, it is commonplace for each individual to acquire various pieces of information and perform communication via the Internet. As such an information terminal, not only the smartphone, but also a smart television capable of receiving information on the Internet via an interface of the television, a smart speaker capable of receiving such information via voices, and the like have been developed, which are appropriately used depending on their purposes and applications.

One example of the communication means using the information terminal is a call. A call, which is communication performed in a conversational style mainly using voices, is capable of implementing natural communication, and is frequently used in the modern life as well. In other words, the information terminal described above is used as a call terminal as well.

Incidentally, in a call involving multiple people, it is important to identify call partners and distinguish the call partners during the call in order to understand conversation in the call and have an appropriate call continued. PTLS 1 and 2 disclose techniques of localizing voices corresponding to voice signals of call partners calling a user, through the use of sound pressure panning, frequency characteristics, and the like.

### CITATION LIST

### Patent Literature

PTL 1: JP H11-68977 A

PTL 2: JP 2004-274147 A

### SUMMARY OF INVENTION

### Technical Problem

However, in the techniques such as PTLS 1 and 2, in a case where the number of call partners is increased during a call, voices corresponding to the voice signals of each of the call partners cannot necessarily be output to the user so that the user can easily hear and distinguish the voices.

An object of one aspect of the present invention is to provide a call terminal that outputs voices corresponding to voice signals of each of call partners to a user so that the user can easily hear and distinguish the voices even when the number of call partners is increased, and techniques pertaining to the call terminal.

### Solution to Problem

A call terminal according to one aspect of the present invention includes: a reception unit configured to receive a voice signal of each of one or more call partners; a localization position determination unit configured to, in a case where one of the one or more call partners is added, determine a localization position corresponding to the voice signal of the added one of the one or more call partners not to overlap with a localization position corresponding to the voice signal of another one of the one or more call partners; and a voice output unit configured to output voice corresponding to each voice signal in manner that the voice is localized at the localization position determined by the localization position determination unit.

A call terminal according to one aspect of the present invention includes: a reception unit configured to receive a voice signal of each of one or more call partners; a localization position determination unit configured to, in a case where one of the one or more call partners is eliminated, determine a localization position corresponding to the voice signal of the eliminated one of the one or more call partners not to overlap with the localization position corresponding to the voice signal of another one of the one or more call partners; and a voice output unit configured to output voice corresponding to each voice signal in manner that the voice is localized at the localization position determined by the localization position determination unit.

A call system according to one aspect of the present invention is a call system including: a call terminal; and a call server, wherein the call terminal receives a voice signal of each of one or more call partners, the call system includes a localization position determination unit configured to, in a case where one of the one or more call partners is added for the call terminal, determine a localization position corresponding to the voice signal of the added one of the one or more call partners received by the call terminal not to overlap with the localization position corresponding to the voice signal of another one of the one or more call partners, and the call terminal outputs voice corresponding to each received voice signal in manner that the voice is localized at the localization position determined by the localization position determination unit.

A control method of a call terminal according to one aspect of the present invention includes: a reception step of using the call terminal to receive a voice signal of each of one or more call partners; a localization position determination step of, in a case where one of the one or more call partners is added, determining a localization position corresponding to the voice signal of the added one of the one or more call partners not to overlap with a localization position corresponding to the voice signal of another one of the one or more call partners; and a voice output step of using the call terminal to output voice corresponding to each voice signal in manner that the voice is localized at the localization position determined in the localization position determination step.

### Advantageous Effects of Invention

According to one aspect of the present invention, the call terminal that outputs voices corresponding to voice signals of each of call partners to a user so that the user can easily hear and distinguish the voices even when the number of call partners is increased, and the techniques pertaining to the call terminal can be provided.

### BRIEF DESCRIPTION OF DRAWINGS

FIG. 1 is a block diagram illustrating a principal configuration of a call terminal according to a first embodiment.

FIG. 2 is a diagram illustrating examples of a localizable range of voices corresponding to voice signals of call partners according to the first embodiment.

FIG. 3 is a diagram illustrating examples of localization positions corresponding to voice signals of call partners according to the first embodiment.

FIG. 4 is a diagram illustrating examples of localization positions corresponding to voice signals of call partners according to the first embodiment.

FIG. 5 is a diagram illustrating examples of localization positions corresponding to voice signals of call partners according to the first embodiment.

FIG. 6 is a diagram illustrating examples of localization positions corresponding to voice signals of call partners according to the first embodiment.

FIG. 7 is a flowchart illustrating an example of the procedure of control processing of the call terminal according to the first embodiment.

FIG. 8 is a block diagram illustrating a principal configuration of a call terminal according to a second embodiment.

FIG. 9 is a diagram illustrating examples of localization positions corresponding to voice signals of call partners according to the second embodiment.

FIG. 10 is a flowchart illustrating an example of the procedure of control processing of the call terminal according to the second embodiment.

FIG. 11 is a block diagram illustrating a principal configuration of a call system according to a third embodiment.

### DESCRIPTION OF EMBODIMENTS

Each embodiment of the present invention will be described below in detail. Note that, unless otherwise specifically noted, the configuration described in these embodiments is not to limit the scope of the present invention only to the configuration.

### First Embodiment

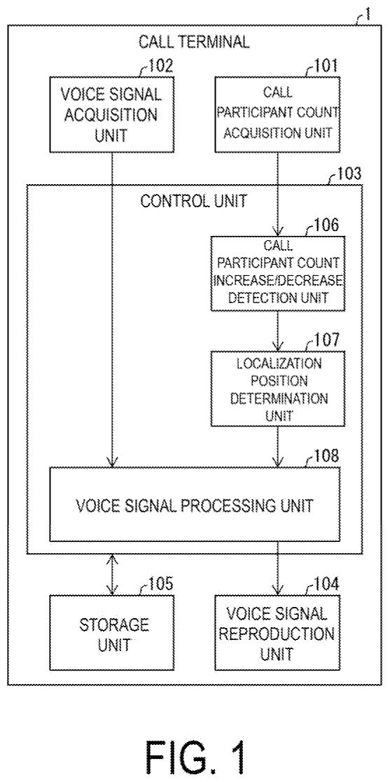

A call terminal 1 and a control method of the call terminal 1 according to a first embodiment will be described below with reference to FIGS. 1 to 7.

### Call Terminal 1

FIG. 1 is a block diagram illustrating a principal configuration of the call terminal 1 according to the first embodiment. As illustrated in FIG. 1, the call terminal 1 includes a call participant count acquisition unit 101, a voice signal acquisition unit (reception unit) 102, a control unit 103, a voice signal reproduction unit (voice output unit) 104, and a storage unit 105.

Note that the call terminal 1 is configured to be capable of implementing a call by a large number of people (at least three people). The call terminal 1 can be appropriately used for a teleconference system, a call system using a VR space, or the like as well. People who participate in a call made by a large number of people are hereinafter referred to as call participants. Among the call participants, a person who operates the call terminal 1 is hereinafter referred to as a user, and people other than the user are hereinafter referred to as call partners.

### Call Participant Count Acquisition Unit 101

The call participant count acquisition unit 101 acquires the number of call partners (call participant count) who are calling the user from the outside of the call terminal 1. In the present embodiment, the call participant count refers to the number of call participants (call partners) among the people who are performing the call, except for the user himself/herself. For example, in a case where a one-to-one call is performed with a certain user, the call participant count is one, whereas in a case where a call among three people is performed, the call participant count is two.

Note that the call participant count acquisition unit 101 may not be included in the call terminals of all of the call participants. For example, the call terminal 1 of the user may serve as a main terminal, and only the call terminal 1 of the user may include the call participant count acquisition unit 101. In this case, information of the call participant count acquired by the call participant count acquisition unit 101 in the call terminal 1 of the user may be configured to be transmitted to the call terminals of other call participants (call partners). In a case where the call terminal 1 does not include the call participant count acquisition unit 101, the call terminal 1 may include, instead of the call participant count acquisition unit 101, a call participant count reception unit 109 (not illustrated) for receiving information of the call participant count from the call terminal 1 that includes the call participant count acquisition unit 101. With this configuration, the call participant count can be efficiently acquired while reducing the processing amount of the entire system. Instead of the call terminal of each call participant, a server 110 (not illustrated) may include the call participant count acquisition unit. In this case, information of the call participant count acquired by the call participant count acquisition unit of the server 110 may be configured to be transmitted to the call terminal of each call participant. With this configuration as well, the call participant count can be efficiently acquired while reducing the processing amount of the entire system.

### Voice Signal Acquisition Unit 102

The voice signal acquisition unit 102 acquires a voice signal of each of one or more call partners. Specifically, the voice signal acquisition unit 102 acquires as many voice signals as the number of the call participant count acquired by the call participant count acquisition unit 101 from the outside of the call terminal 1.

In the present embodiment, the voice signal is a voice signal corresponding to the voice of the call partner(s) with which the user performs a call, and preferably is a voice signal in a monaural format. The voice signal acquisition unit 102 may be configured to acquire the voice signal that is compressed with some compression method. In this case, the voice signal acquisition unit 102 decodes the acquired voice signal with an appropriate decoding method. The voice signal acquisition unit 102 may be configured to acquire the voice signal in a format other than the monaural format, that is, the voice signal having two or more channels. In this case, the voice signal acquisition unit 102 may be configured to downmix the acquired multi-channel voice signal into a monaural signal. The decoding of the compressed voice signal and the downmix of the voice signal into a monaural signal described above may be performed in the voice signal processing unit 108 to be described later.

### Control Unit 103

The control unit 103 controls the call participant count acquisition unit 101, the voice signal acquisition unit 102, the voice signal reproduction unit 104, and the storage unit 105, and inputs and outputs data to and from each of these units. The control unit 103 is, for example, implemented by a central processing unit (CPU) executing a program stored in a prescribed memory. The control unit 103 includes a call participant count increase/decrease detection unit 106, a localization position determination unit 107, and a voice signal processing unit 108.

### Call Participant Count Increase/Decrease Detection Unit 106

The call participant count increase/decrease detection unit 106 detects an increase or a decrease of the call participant count. Specifically, the call participant count increase/decrease detection unit 106 acquires information of the call participant count from the call participant count acquisition unit 101, and detects whether the call participant count is increased or decreased with respect to the previously acquired call participant count. The call participant count increase/decrease detection unit 106 transmits the increased or decreased call participant count and information of the increased or decreased call partner(s) to the localization position determination unit 107, as well as the detection results of the increase or the decrease of the call participant count.

### Localization Position Determination Unit 107

In a case where a call partner is added, the localization position determination unit 107 determines the localization position corresponding to the voice signal of the added call partner so as not to overlap with the localization positions corresponding to the voice signals of other call partners. In a case where a call partner is eliminated, the localization position determination unit 107 determines the position corresponding to the voice signal of the eliminated call partner so as not to overlap with the localization positions corresponding to the voice signals of other call partners. In a case where the call participant count is increased or decreased, the localization position determination unit 107 receives a notification indicating that the call participant count is increased or decreased from the call participant count increase/decrease detection unit 106. In this case, the localization position determination unit 107 changes the localization positions corresponding to the voice signals of respective call partners so that the localization positions do not overlap with each other, based on the increase or the decrease of the call participant count. With this configuration, even in a case where the server 110 side calculates the localization positions, the call terminal 1 side can determine the localization positions in a case where the voice signals acquired by the voice signal acquisition unit 102 are caused to be reflected in localization of the voices to be output. Further, even when the number of call partners is increased or decreased, the voices corresponding to the voice signals of each of the call partners can be output so that the user can easily hear and distinguish the voices. The details of the determination method of the localization position corresponding to the voice signal of the call partner by the localization position determination unit 107 will be described later.

### Voice Signal Processing Unit 108

The voice signal processing unit 108 configures voices to be reproduced from the voice signal reproduction unit 104, based on the localization positions corresponding to the voice signals of each of the call partners obtained from the localization position determination unit 107 and the voice signals of each of the call partners obtained from the voice signal acquisition unit 102.

Here, the voices configured by the voice signal processing unit 108 are voices able to have the user perceive the localization positions corresponding to the voice signals of each of the call partners determined by the localization position determination unit 107. The method of implementing the voice is determined depending on the configuration of the voice signal reproduction unit 104. For example, in a case where the voice signal reproduction unit 104 is a pair of headphones or earphones, the voice signal processing unit 108 configures a binaural voice signal that is implemented by using the head-related transfer function (HRTF). In this manner, the voice signal processing unit 108 has the user perceive the position of the voice corresponding to the voice signal of each of the call partners. In contrast, in a case where the voice signal reproduction unit 104 is a stereo speaker, the voice signal processing unit 108 may have the user perceive the position of the voice by configuring a transaural voice signal using the head-related transfer function described above. The voice signal processing unit 108 may configure the voice signal by using sound pressure panning such as vector base amplitude panning (VBAP).

Note that the above example provides description on the assumption that the voice signal of each of the call partners acquired by the voice signal processing unit 108 is a monaural signal. Note that, in a case where the voice signal of a specific call partner obtained from the voice signal acquisition unit 102 is a stereo (2-ch) voice signal or of higher quality, the voice signal processing unit 108 may convert the voice signal into a monaural signal through downmix or the like.

### Voice Signal Reproduction Unit 104

The voice signal reproduction unit 104 outputs the voice corresponding to each voice signal so that the voice is localized at the localization position determined by the localization position determination unit 107. In this manner, even when the number of call partners is increased or decreased, the voices corresponding to the voice signals of each of the call partners can be output so that the user can easily hear and distinguish the voices. The voice signal reproduction unit 104 reproduces each voice signal that has been subjected to sound effect processing by the control unit 103 through the speaker, the headphones, the earphones, or the like that is connected to the voice signal reproduction unit 104. In this manner, the voice signal reproduction unit 104 can appropriately output the voices and have the user hear the voices.

### Storage Unit 105

The storage unit 105 includes a secondary storage apparatus for storing prescribed data used by the control unit 103. The storage unit 105 is, for example, implemented as a magnetic disk, an optical disc, or a flash memory. Specifically, the storage unit 105 is implemented as a hard disk drive (HDD), a solid state drive (SSD), a Blu-Ray (registered trademark) (BD Disc), or the like. The control unit 103 can read data from the storage unit 105 and record data into the storage unit 105 as necessary.

### Operation of Localization Position Determination Unit 107

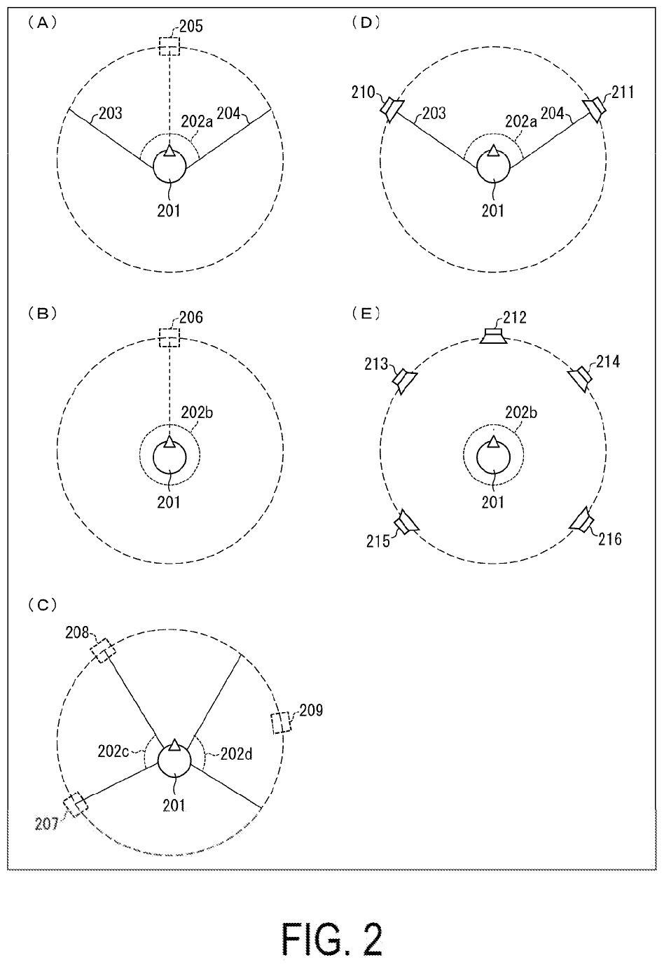

Next, the operation of the localization position determination unit 107 will be described below in detail with reference to FIGS. 2 to 6.

### Configuration of Localizable Range

The localization position determination unit 107 may configure a localizable range, which is a range in which each voice can be localized, before determining the localization position of the voice corresponding to each voice signal. In this manner, the localization position of each voice can be more appropriately determined. Note that the localization position determination unit 107 may determine the localization position of each voice without configuring the localizable range. The configuration method of the localizable range by the localization position determination unit 107 will be described below with reference to FIG. 2. FIG. 2 is a diagram illustrating examples of the localizable range according to the first embodiment.

### Configuration Example 1 of Localizable Range

In one aspect, for example, as illustrated in (A) of FIG. 2, the localization position determination unit 107 may configure a localizable range 202a, which is defined between a localizable range start position 203 and a localizable range end position 204 within a circle about a user 201 (around the user 201). In this case, the localization position determination unit 107 determines the localization position (for example, the localization position 205) of each voice in the localizable range 202a.

In one aspect, for example, the call terminal 1 may include a range input unit 111 (not illustrated), such as a keyboard or a touch panel, that receives input of the localizable range from the user 201, and the localization position determination unit 107 may configure the range input into the range input unit 111 as the localizable range. For example, the range input unit 111 is configured to receive input of the localizable range start position 203 and the localizable range end position 204, and the localization position determination unit 107 configures the range defined between the localizable range start position 203 and the localizable range end position 204 as the localizable range 202a.

In this manner, in a case where the number of call partners is small, for example, the range to which attention should be paid during a call can be reduced by limiting the localizable range 202a, whereas in a case where the number of call partners is large, for example, the voices originating from each of the call partners can be made to be more easily heard and distinguished by widening the localizable range 202a.

Note that the radius of the circle about the user 201 being used for defining the localizable range is not specifically limited, and may be set to any distance. For example, the localization position determination unit 107 may determine the radius of the circle by receiving the distance from the user 201 to the localization position of the voice via any command input unit 112 (not illustrated), such as a keyboard or a touch panel, from the user 201.

### Configuration Example 2 of Localizable Range

The user 201 may input the localizable range start position 203 and the localizable range end position 204 to be the same. The user 201 may omit the input of the localizable range. In such cases, as illustrated in (B) of FIG. 2, the localization position determination unit 107 may configure the localizable range to be a localizable range 202b, which corresponds to the whole circle about the user 201. In this case, the localization position determination unit 107 determines the localization position (for example, the localization position 206) of each voice in the localizable range 202b.

### Configuration Example 3 of Localizable Range

The above example describes a case in which the localizable range is a continuous range. However, the localizable range need not necessarily be such a continuous range. For example, as illustrated in (C) of FIG. 2, the localization position determination unit 107 may configure multiple non-continuous localizable ranges 202c and 202d as the localizable range.

### Configuration Example 4 of Localizable Range

In one aspect, the call terminal 1 may include a detection unit 113 (not illustrated) that detects ambient sound of the call terminal 1, and the localization position determination unit 107 may determine the localization position corresponding to each voice signal so as to avoid the generation source of the sound detected by the detection unit 113.

For example, in a case where the detection unit 113 detects sound such as television sound from the front side of the user 201, as illustrated in (C) of FIG. 2, the localization position determination unit 107 configures the non-continuous localizable ranges 202c and 202d except for the front side of the user 201 as the localizable range, and determines localization positions 207 to 209 of each voice in the localizable ranges 202c and 202d. In this manner, the localization position determination unit 107 can determine the localization position corresponding to each voice signal so as to avoid the generation source of the sound detected by the detection unit 113.

In this manner, for example, even in a case where sound such as television sound is generated from a certain direction, the voices originating from the call partners can be arranged to be heard from a direction different from the generation source of the sound. In this manner, the user 201 can be made to more easily hear and distinguish the voices originating from each of the call partners. Note that, as long as the configuration of determining the localization position of each voice so as to avoid the generation source of sound is adopted, the configuration is not limited to the configuration of configuring the localizable range so as to avoid the generation source of sound. The localization position determination unit 107 may be configured to determine the localization position of each voice so as to avoid the generation source of sound in a freely configured localizable range.

### Configuration Example 5 of Localizable Range

In one aspect, the localization position determination unit 107 may configure the localizable range, based on the range in which the voice signal reproduction unit 104 can actually localize the output voice. Specifically, the localization position determination unit 107 may configure the localizable range, based on the position of the voice signal reproduction unit 104 or the position of the voice signal reproduction unit 104 and a voice signal configuration method of the voice signal processing unit 108.

For example, as illustrated in (D) of FIG. 2, it is assumed that the voice signal reproduction unit 104 is stereo speakers 210 and 211, and the voice signal configuration method of the voice signal processing unit 108 is VBAP. In this case, the range in which the voice signal reproduction unit 104 can localize the output voice is a range between the stereo speaker 210 and the stereo speaker 211. In this case, the localization position determination unit 107 may determine a line connecting the user 201 and the stereo speaker 210 as the localizable range start position 203, and configure a line connecting the user 201 and the stereo speaker 211 as the localizable range end position 204.

As illustrated in (E) of FIG. 2, in a case where the voice signal reproduction unit 104 is 5.1-ch multi-channel speakers 212 to 214 disposed adjacently to each other on the circle about the user 201, and the voice signal configuration method of the voice signal processing unit 108 is VBAP, the voice signal reproduction unit 104 can localize the output voice at omnidirectional positions as seen from the user 201. In this case, the localization position determination unit 107 may configure, for example, the localizable range 202b illustrated in (B) of FIG. 2 as the localizable range.

### Configuration Example 6 of Localizable Range

In the above example, the localization position determination unit 107 configures the localizable range in advance. However, the present embodiment is not limited to this. In the present embodiment, the localization position determination unit 107 may configure or change (reconfigure) the localizable range during a call.

For example, during a call, the call terminal 1 may receive a change command of the localization position from the user 201 via the command input unit 112, and the localization position determination unit 107 may change the localization position corresponding to each voice signal, based on the change command. In this manner, for example, during a call, in a case where it is difficult to hear the voices originating from each of the call partners due to a reason such as that the range of the localization position is excessively wide or is excessively narrow, by changing the configuration of the localizable range, the localization positions of the voices originating from each of the call partners can be changed to the positions that allow the voices to be more easily heard and distinguished.

### Configuration Example 7 of Localizable Range

In the above example, the localization position determination unit 107 configures at least a part of the range in the circle about the user 201 as the localizable range. However, the present embodiment is not limited to this. In the present embodiment, the localization position determination unit 107 can determine any range as the localizable range. In one aspect, the localization position determination unit 107 may configure at least a part of the range on a semicircle about the user 201 as the localizable range. In this case, the localization position determination unit 107 can determine the above of the user 201 as the localization position of the voice. Further, in one aspect, the localization position determination unit 107 may configure a range on the circumference of the circle about the user 201 as the localizable range, and determine the localization position of each voice on the circumference. Further, in one aspect, the localizable range may have a shape other than a circle.

### Determination of Localization Position

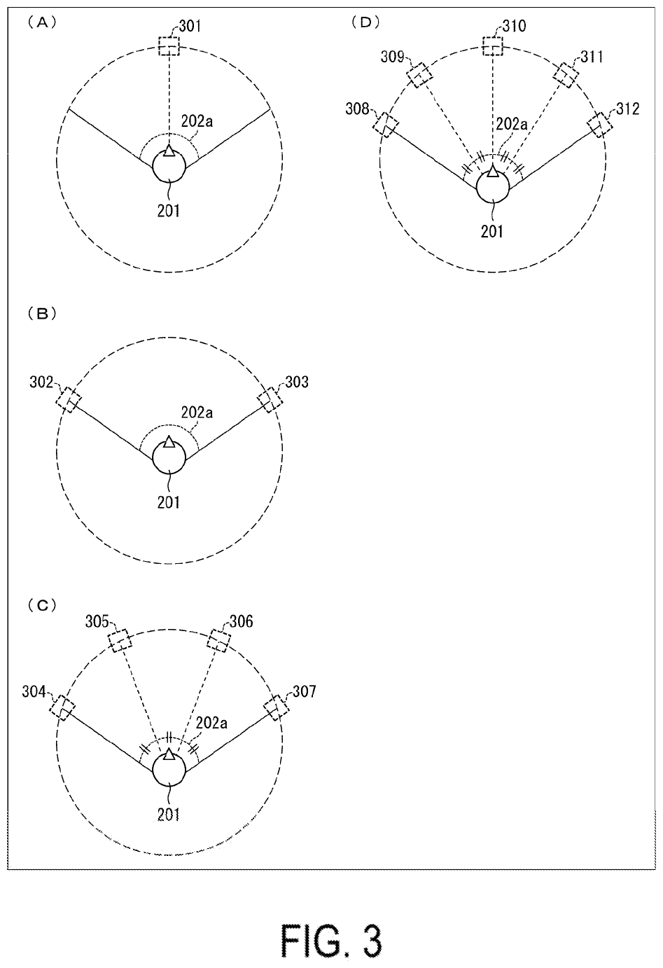

Next, the determination method of the localization position corresponding to the voice signal of the call partner in a case where a call has just been started and the call participant count is acquired for the first time will be described with reference to FIGS. 3 to 6.

### Determination Example 1 of Localization Position

An example of the determination method of the localization position of the voice (output voice originating from each call partner) corresponding to the voice signal of each call partner by the localization position determination unit 107 will be described with reference to FIG. 3. Note that, in the following description, it is assumed that the localization position determination unit 107 configures the localizable range 202a.

In a case where the number of call partners is one, as illustrated in (A) of FIG. 3, the localization position determination unit 107 determines a localization position 301 which is determined in advance in the localizable range 202a as the localization position of the voice originating from the call partner. Note that, although the localization position 301 is a position in front of the user 201, this is not restrictive. The localization position determination unit 107 may determine another position, or the localization position may be determined based on a command of the user 201 via the command input unit 112.

In a case where the number of call partners is two or more, the localization position determination unit 107 determines the localization positions of the voices originating from each of the call partners so that the localization positions of the voices do not overlap with each other. Specifically, the localization position determination unit 107 determines the localization positions of the voices originating from each of the call partners at positions different from each other in the localizable range 202a, and preferably determines the localization positions of the voices originating from each of the call partners so that the directions in which the voices originating from each of the call partners arrive the user 201 do not overlap with each other. For example, as illustrated in (B) of FIG. 3, the localization position determination unit 107 may determine localization positions 302 and 303 of the voices originating from each of the call partners at both the ends of the localizable range 202a.

In one aspect, the localization positions corresponding to each voice signal may be determined so that the intervals between the adjacent localization positions are uniform in the localizable range 202a. For example, as illustrated in (C) and (D) of FIG. 3, the localization position determination unit 107 determines the localization positions so that the intervals between two adjacent localization positions are uniform in the localizable range 202a of the voices. For example, in a case where the number of call partners is four, as illustrated in (C) of FIG. 3, the localization position determination unit 107 determines each of the localization positions of the voices originating from the four call partners at the positions of both the ends of the localizable range 202a of the voices and the positions to equally divide the localizable range 202a into three parts. For example, in a case where the number of call partners is five, as illustrated in (D) of FIG. 3, the localization position determination unit 107 determines each of the localization positions of the voices originating from the five call partners at the positions of both the ends of the localizable range 202a of the voices and the positions to equally divide the localizable range 202a into four parts. In this manner, the voices originating from each of the call partners can be more easily heard and distinguished.

As described above, when the localization position determination unit 107 determines the localization positions of the voices originating from each of the call partners based on the number of call partners, the voices of each of the call partners can be output so that the user 201 can more easily hear and distinguish the voices, depending on the number of call partners.

### Determination Example 2 of Localization Position

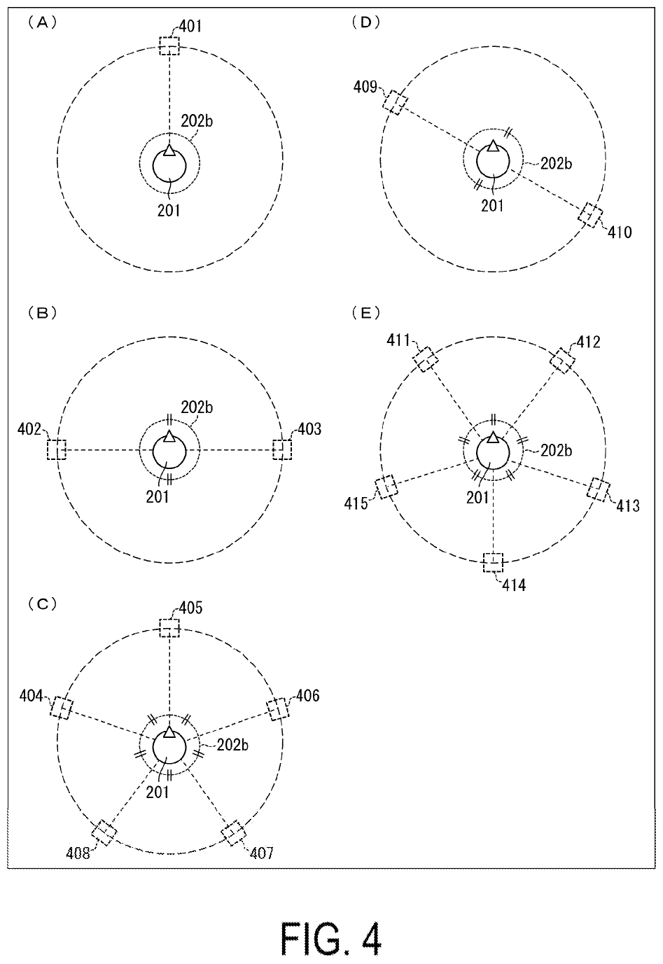

Another example of the determination method of the localization position of the voice (output voice originating from each call partner) corresponding to the voice signal of the call partner by the localization position determination unit 107 will be described with reference to FIG. 4. Note that, in the following description, it is assumed that the localization position determination unit 107 configures the localizable range 202b.

In a case where the number of call partners is one, as illustrated in (A) of FIG. 4, the localization position determination unit 107 determines a localization position 401 which is determined in advance and is a position in front of the user 201 in the localizable range 202b, for example, as the localization position. Note that the position of the localization position 401 is not limited to this.

In a case where the number of call partners is two or more, the localization position determination unit 107 determines the localization positions of the voices originating from each of the call partners so that the localization positions of the voices do not overlap with each other. Specifically, the localization position determination unit 107 determines the localization positions of the voices originating from each of the call partners at positions different from each other in the localizable range 202b, and preferably determines the localization positions of the voices originating from each of the call partners so that the directions in which the voices originating from each of the call partners arrive the user 201 do not overlap with each other.

In one aspect, the localization positions corresponding to each voice signal may be determined so that the intervals between the adjacent localization positions are uniform in the localizable range 202b.

For example, as illustrated in (B) and (C) of FIG. 4, the localization position determination unit 107 determines the localization positions so that the intervals between two adjacent localization positions are uniform in the localizable range 202b of the voices. For example, in a case where the number of call partners is two, as illustrated in (B) of FIG. 4, the localization position determination unit 107 determines the localization positions of the voices originating from the two call partners at the positions to equally divide the localizable range 202b of the voices into two parts. For example, in a case where the number of call partners is five, as illustrated in (C) of FIG. 4, the localization position determination unit 107 determines the localization positions of the voices originating from the five call partners at the positions to equally divide the localizable range 202b of the voices into five parts. In this manner, the voices originating from each of the call partners can be more easily heard and distinguished.

When equally dividing the localizable range 202b into parts, the localization position determination unit 107 can equally divide the localizable range 202b in any manner of equal division. For example, when the call participant count is two and the localization position determination unit 107 determines the positions to equally divide the localizable range 202b into two parts as the localization positions of the voices originating from each of the call partners, the localization position determination unit 107 may determine localization positions 409 and 410 illustrated in (D) of FIG. 4 instead of localization positions 402 and 403 illustrated in (B) of FIG. 4. When the call participant count is five and the localization position determination unit 107 determines the positions to equally divide the localizable range 202b of the voices into five parts as the localization positions of the voices originating from each of the call partners, the localization position determination unit 107 may determine localization positions 411 to 415 illustrated in (E) of FIG. 4 instead of localization positions 404 to 408 illustrated in (C) of FIG. 4.

### Determination Example 3 of Localization Position

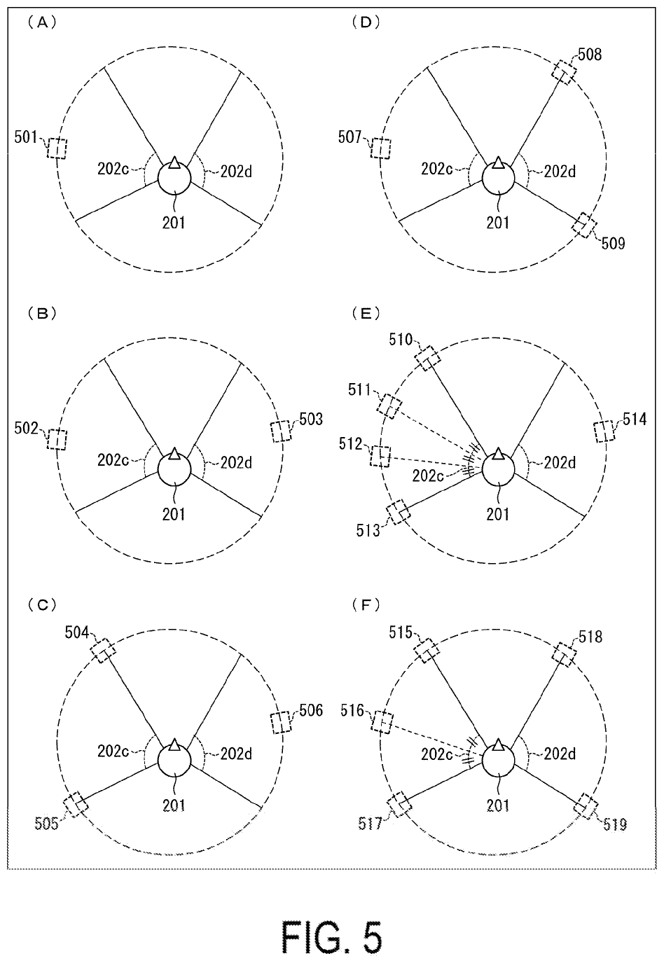

Another example of the determination method of the localization position of the voice (output voice originating from each call partner) corresponding to the voice signal of the call partner by the localization position determination unit 107 will be described with reference to FIG. 5. Note that, in the following description, it is assumed that the localization position determination unit 107 configures the localizable ranges 202c and 202d.

In a case where the number of call partners is one, the localization position determination unit 107 determines the localization position which is determined in advance in any of the localizable ranges 202c and 202d as the localization position of the voice originating from the call partner. For example, as illustrated in (A) of FIG. 5, the localization position determination unit 107 may determine a localization position 501 which is determined in advance in the localizable range 202c as the localization position of the voice originating from the call partner.

In a case where the number of call partners is two or more, the localization position determination unit 107 determines the localization positions of the voices originating from each of the call partners so that the localization positions of the voices do not overlap with each other. In this case, the localization position determination unit 107 determines the localization positions so that the localization positions are distributed in both of the localizable range 202c and the localizable range 202d.

For example, in a case where the number of call partners is two, as illustrated in (B) of FIG. 5, the localization position determination unit 107 determines one localization position in each of the localizable ranges 202c and 202d (the localization position 502 in the localizable range 202c and the localization position 503 in the localizable range 202d).

Further, for example, in a case where the number of call partners is three, as illustrated in (C) of FIG. 5, the localization position determination unit 107 may determine two localization positions (504 and 505) in the localizable range 202c and determine one localization position (506) in the localizable range 202d. As illustrated in (D) of FIG. 5, the localization position determination unit 107 may determine one localization position (507) in the localizable range 202c and determine two localization positions (508 and 509) in the localizable range 202d.

Further, for example, in a case where the number of call partners is five, the localization position determination unit 107 determines the localization positions so that the intervals between the adjacent localization positions of the voices of the call participants are uniform in each of the localizable ranges 202c and 202d. In this case, for example, as illustrated in (E) of FIG. 5, the localization position determination unit 107 may determine four localization positions 510 to 513 in the localizable range 202c and determine one localization position 514 in the localizable range 202d. As illustrated in (F) of FIG. 5, the localization position determination unit 107 may determine three localization positions 515 to 517 in the localizable range 202c and determine two localization positions 518 and 519 in the localizable range 202d.

In this case, as illustrated in (E) and (F) of FIG. 5, it is preferable that the localization position determination unit 107 determine each of the localization positions so that the intervals between the adjacent localization positions of the voices of the call participants are uniform in at least one of the localizable ranges 202c and 202d of the voices.

In this manner, by determining the localization positions so that the intervals between the adjacent localization positions of the voices of the call participants are uniform in at least one of the localizable ranges 202d and 202d in a case where the call participant count is three or more, the voices of each of the call participants can be easily localized at the positions where the user 201 can easily hear and distinguish the voices.

### Determination Example 4 of Localization Position

In the above example, in a case where the number of call partners is a prescribed number or more, the localization position determination unit 107 determines each of the localization positions in the localizable range so that the intervals between the adjacent localization positions are uniform. Note that the localization position determination unit 107 need not determine each of the localization positions so that the intervals between the adjacent localization positions are uniform.

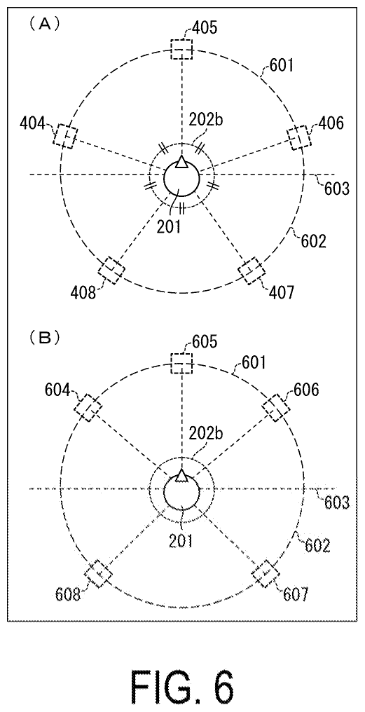

With reference to FIG. 6, an example of the determination method of the localization position of the voice of the call participant by the localization position determination unit 107 will be described below. FIG. 6 is a diagram illustrating an example of the localization position of the voice according to the first embodiment.

For example, in a case where the number of call partners is five, the localization position determination unit 107 may equally divide the localizable range 202b into five parts as illustrated in (A) of FIG. 6, or may not equally divide the localizable range 202b into five parts as illustrated in (B) of FIG. 6. In particular, in a case where the localizable range 202b is divided into a front region 601 and a rear region 602 by a boundary line 603, the user 201 may perceive the voices from the rear less clearly than the voices from the front. In this case, as illustrated in (B) of FIG. 6, the localization position determination unit 107 can output each voice to the user more appropriately by determining the interval between localization positions 607 and 608 in the rear region 602 to be wider than each of the intervals between adjacent ones of localization positions 604 to 606 in the front region 601.

The localization position determination unit 107 may determine each of the localization positions so that the localization positions of the voices originating from each of the call partners are separated away from each other at least by a prescribed angle or more as seen from the user 201. Although the prescribed angle is not particularly limited, the prescribed angle may be set to 1 degree, 5 degrees, 10 degrees, 15 degrees, 20 degrees, 25 degrees, 30 degrees, or the like, as appropriate. In this manner as well, the localization positions can be determined in a range where the user 201 can easily hear the voices of the call partners.

### Change of Localization Position

Next, the change method of the localization positions of the voices originating from the call partners by the localization position determination unit 107 in a case where the call participant count is increased or decreased will be described. As described above, the localization position determination unit 107 changes the localization positions so that the localization positions of the voices originating from each of the call partners do not overlap with each other, based on the increase or the decrease of the call participant count.

In a conventional call that assumes a one-to-one call, as a matter of course, when one of the call partners ends the call, the call itself ends. In contrast, in a call involving a large number of people including the user (multi-person call), even when any one of the call participants (call partners) ends the call, the call itself is maintained by the remaining call participants. It is conceivable that a new call partner is added to an ongoing multi-person call. In this manner, in the multi-person call, a call partner may be increased or decreased in the middle of the call. In this case, in a voice-only call without an image, as compared to a call with an image, it is more difficult to hear and distinguish the voices corresponding to the voice signals of the call partners. In view of this, as described above, by changing the localization positions corresponding to the voice signals of each of the call partners so that the localization positions do not overlap with each other based on the increase or the decrease of the call participant count, the voices corresponding to the voice signals of each of the call partners can be output so that the user can easily hear and distinguish the voices even when the call participant count is increased or decreased.

Case where Call Partner is Increased (Added)

In the present embodiment, in a case where the call participant count increase/decrease detection unit 106 detects that the call partner has been increased (added), the localization position determination unit 107 (i) determines the localization position corresponding to the voice signal of the added call partner so as not to overlap with the localization positions corresponding to the voice signals of other call partners (call partners before the addition), and (ii) changes the localization positions corresponding to the voice signals of such other call partners according to the number of call partners after the addition while maintaining the relative positional relationship (order) thereof.

For example, in one aspect, the localization position determination unit 107 determines the localization positions corresponding to the voice signals of each of the call partners after addition in a manner similar to determination examples 1 to 4 of the localization position described above. In this case, it is arranged that the relative positional relationship (order) be maintained between the localization positions corresponding to the voice signals of the call partners existing before addition. The following is a description provided by taking specific examples.

For example, as illustrated in (C) of FIG. 3, it is assumed that the number of call partners has increased to five from a call state in which the number of call partners is four. It is assumed that the call partners before the increase are call partners A to D, and a call partner E is added. Further, localization positions 304 to 307 illustrated in (C) of FIG. 3 respectively correspond to the voice signals of the call partners A to D.

In this case, as illustrated in (D) of FIG. 3, the localization position determination unit 107 changes the localization positions corresponding to the voice signals of the call partners A to D respectively to localization positions 308 to 311, and determines the localization position corresponding to the voice signal of the call partner E at the localization position 312.

Here, the localization positions 308 to 312 are determined in the localizable range 202a so that the intervals between the adjacent localization positions are uniform, in a manner similar to determination example 1 of the localization position. Note that the determination method of the localization positions corresponding to the voice signals of the call partners A to E is not limited to this, and the intervals between the adjacent localization positions may not be uniform as in determination example 4 of the localization position. In any case, the localization positions 308 to 312 are determined based on the number of call partners after addition.

The localization position determination unit 107 changes the localization positions so as not to change the relative positional relationship of the localization positions corresponding to the voice signals of each of the call partners illustrated in (C) of FIG. 3. Specifically, the localization position determination unit 107 changes the localization positions so that the voice localized at the localization position 304 is localized at the localization position 308, the voice localized at the localization position 305 is localized at the localization position 309, the voice localized at the localization position 306 is localized at the localization position 310, and the voice localized at the localization position 307 is localized at the localization position 311. Then, the localization position determination unit 107 determines the localization position corresponding to the voice signal of the newly added call partner at the localization position 312 being a right end position for the user 201.

Note that the present embodiment is not limited to this, and the localization position determination unit 107 may determine the localization position corresponding to the voice signal of the newly added call partner at another position for the user 201. For example, the localization position determination unit 107 may determine the localization position corresponding to the voice signal of the call partner newly added to the localization position 308 illustrated in (D) of FIG. 3. In this case, the localization position determination unit 107 changes the localization positions so that the voice localized at the localization position 304 is localized at the localization position 309, the voice localized at the localization position 305 is localized at the localization position 310, the voice localized at the localization position 306 is localized at the localization position 311, and the voice localized at the localization position 307 is localized at the localization position 312. In this manner, the relative positional relationship of the localization positions corresponding to the voice signals of each of the call partners before the call partner is added can be maintained in a manner similar to the above example.

Note that the above example describes a case in which the number of call partners is increased by one between four and five. However, the present embodiment is not limited to this. In the present embodiment, the number of call partners may be increased in any number. In such a case as well, in a manner similar to the above example, it is only necessary that the localization position determination unit 107 determine the localization positions corresponding to the voice signals of each of the call partners after addition in a manner similar to determination examples 1 to 4 of the localization position described above, and maintain the relative positional relationship (order) between the localization positions corresponding to the voice signals of the call partners existing before addition.

As described above, in a case where the call partner is added, by (i) determining the localization position corresponding to the voice signal of the added call partner so as not to overlap with the localization positions corresponding to the voice signals of other call partners (call partners before the addition) and (ii) changing the localization positions corresponding to the voice signals of such other call partners according to the number of call partners after the addition while maintaining the relative positional relationship (order) thereof, (i) the user can appropriately hear and distinguish the voice originating from the newly added call partner, and by (ii) maintaining the relative positional relationship (order) of the localization positions of the voices originating from the previously existing call partners, the user can be prevented from incorrectly recognizing the call partners.

Case where Call Partner is Reduced (Eliminated)

In the present embodiment, in a case where the call participant count increase/decrease detection unit 106 detects that the call partner has been reduced (eliminated), the localization position determination unit 107 changes the localization positions corresponding to the voice signals of the remaining call partners according to the number of call partners after the elimination while maintaining the relative positional relationship (order) thereof.

For example, in one aspect, the localization position determination unit 107 determines the localization positions corresponding to the voice signals of each of the call partners after elimination in a manner similar to determination examples 1 to 4 of the localization position described above. In this case, it is arranged that the relative positional relationship (order) be maintained between the localization positions corresponding to the voice signals of the remaining call partners. The following is a description provided by taking specific examples.

For example, as illustrated in (D) of FIG. 3, it is assumed that the call partner that emits the voice localized at the localization position 311 has ended the call and the call participant count is decreased to 4 from a call state in which the call participant count is five. In this case, the localization position determination unit 107 changes the localization positions corresponding to the voice signals of the call partners to the localization positions 304 to 307 illustrated in (C) of FIG. 3. Here, the localization position determination unit 107 changes the localization positions so as not to change the relative positional relationship (order) of the localization positions corresponding to the voice signals of each of the call partners illustrated in (D) of FIG. 3. Specifically, the localization position determination unit 107 changes the localization positions so that the voice localized at the localization position 308 is localized at the localization position 304, the voice localized at the localization position 309 is localized at the localization position 305, the voice localized at the localization position 310 is localized at the localization position 306, and the voice localized at the localization position 312 is localized at the localization position 307.

Note that the above example describes a case in which the number of call partners is decreased by one between four and five. However, the present embodiment is not limited to this. In the present embodiment, the number of call partners may be decreased in any number. In such a case as well, in a manner similar to the above example, it is only necessary that the localization position determination unit 107 determine the localization positions corresponding to the voice signals of each of the call partners after elimination in a manner similar to determination examples 1 to 4 of the localization position described above, and maintain the relative positional relationship (order) between the localization positions corresponding to the voice signals of the remaining call partners.

As described above, in a case where the call partner is eliminated, by changing the localization positions corresponding to the voice signals of the remaining call partners according to the number of call partners after the elimination while maintaining the relative positional relationship (order) thereof, (i) the user can appropriately hear and distinguish the voices originating from the remaining call partners, and (ii) the user can be prevented from incorrectly recognizing the call partners.

### Change of Localization Position During Call

The localization position determination unit 107 may change the localization position of the voice originating from the call partner during a call. In this manner, even in a case where it is difficult for the user 201 to hear and distinguish the voices localized at the localization positions of the voices determined in advance, the user 201 can cause the localization position determination unit 107 to change the localization positions of the voices originating from each of the call partners afterwards by inputting a change command via the command input unit 112, for example. As a result, the localization positions of the voices originating from each of the call partners can be determined at appropriate positions where the user 201 can more easily hear and distinguish the voices.

In a case where the change command via the command input unit 112 is a rotation command of the localization positions, the localization position determination unit 107 may rotate the localization positions of the voices originating from each of the call partners about the user 201 (listener of each voice), based on the rotation command.

For example, it is assumed that the number of call partners is two, and the localization position determination unit 107 determines the localizable range to be the localizable range 202b. In this case, based on the command of the user 201, the localization position determination unit 107 may perform rotation from the localization positions 402 and 403 illustrated in (B) of FIG. 4 to the localization positions 409 and 410 illustrated in (D) of FIG. 4 about the user 201 (listener of each voice). Then, the localization position determination unit 107 may determine the localization positions of the voices originating from each of the call partners at the localization positions 409 and 410 after the rotation.

Further, for example, it is assumed that the number of call partners is five, and the localization position determination unit 107 determines the localizable range to be the localizable range 202b. In this case, based on the command of the user 201, the localization position determination unit 107 may rotate the localization positions 404 to 408 of the voices originating from each of the call partners illustrated in (C) of FIG. 5 to the localization positions 411 to 415 illustrated in (E) of FIG. 5 about the user 201 (listener of each voice). Then, the localization position determination unit 107 may determine the localization positions of the voices originating from each of the call partners at the localization positions 411 to 415 after the rotation.

In this manner, for example, even in a case where it is difficult to hear and distinguish the voices originating from each of the call partners heard from the localization positions of the voices determined in advance during a call with the call partners, the localization positions of the voices originating from the call partners can be changed to the positions where the user 201 can more easily hear and distinguish the voices originating from each of the call participants.

### Control Processing of Call Terminal 1

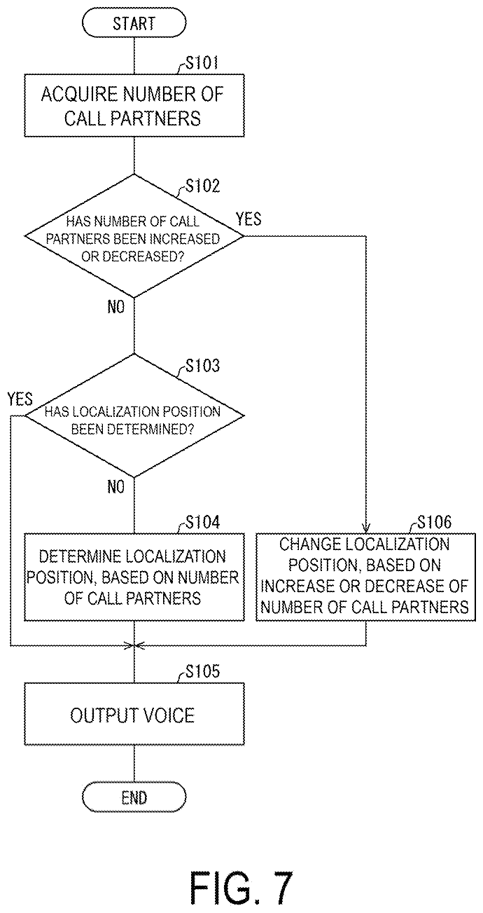

Next, with reference to FIG. 7, the procedure of the control processing of the call terminal 1 (control method of the call terminal) according to the present embodiment will be described. FIG. 7 is a flowchart illustrating an example of the procedure of the control processing of the call terminal 1 according to the first embodiment.

In Step S101, the call participant count acquisition unit 101 acquires the number of call partners from the outside of the call terminal 1. The voice signal acquisition unit 102 acquires the voice signals of each of one or more call partners (reception step).

In Step S102, the call participant count increase/decrease detection unit 106 acquires the number of call partners from the call participant count acquisition unit 101, and determines whether or not the number of call partners has increased or decreased. In a case where the call participant count increase/decrease detection unit 106 determines that the number of call partners has increased or decreased (YES in Step S102), the processing proceeds to Step S106. In a case where the call participant count increase/decrease detection unit 106 determines that the number of call partners has not increased or decreased (NO in Step S102), the processing proceeds to Step S103.

In Step S103, in a case where the localization position determination unit 107 has not yet determined the localization positions corresponding to the voice signals of each of the call partners (NO in Step S103), the processing proceeds to Step S104. In Step S103, in a case where the localization position determination unit 107 has already determined the localization positions corresponding to the voice signals of each of the call partners (YES in Step S103), the processing proceeds to Step S105 without changing the current localization positions corresponding to the voice signals of the call partners.

In Step S104, the localization position determination unit 107 determines the localization positions corresponding to the voice signals of each of the call partners, based on the number of call partners. For example, in a case where the number of call partners is one, the localization position determination unit 107 determines the localization positions corresponding to the voice signals of the call partners at the localization positions determined in advance. In a case where the number of call partners is two or more, the localization position determination unit 107 determines the localization positions corresponding to the voice signals of each of the call partners so as not to overlap with the localization positions corresponding to the voice signals of other call partners (localization position determination step). In this case, the localization position determination unit 107 may determine the localization positions so that the intervals between the adjacent localization positions corresponding to the voice signals of the call partners are uniform. Subsequently, the processing proceeds to Step S105.

In Step S105, the voice signal reproduction unit 104 outputs the voices corresponding to each of the voice signals so that the voices are localized at the localization positions determined in the localization position determination step, and ends the processing (voice output step).

In Step S106, the localization position determination unit 107 changes the localization positions corresponding to the voice signals of each of the call partners, based on the increase or the decrease of the number of call partners (localization position change step). In this case, the localization position determination unit 107 changes the localization positions of the voice signals of each of the call partners so that the relative positional relationship (order) of the localization positions of the voice signals is not changed between the previously existing call partners.

For example, in one aspect, in a case where the call partner is added, the localization position determination unit 107 may change the localization positions corresponding to each of the voice signals according to the number of call partners after the addition while maintaining the order of localization positions corresponding to the voice signals of the call partners before the addition. In one aspect, in a case where the call partner is eliminated, the localization position determination unit 107 may change the localization positions corresponding to each of the voice signals according to the number of call partners after the elimination while maintaining the order of localization positions corresponding to the voice signals of the remaining call partners.

Note that one example of an aspect in which the localization position determination unit 107 changes the localization positions corresponding to each of the voice signals according to the number of call partners after the increase or the decrease (after the addition or after the elimination) is an example in which the localization position determination unit 107 changes each of the localization positions so that the intervals between the localization positions corresponding to the voice signals of each of the call partners are uniform.

Owing to the configuration described above, the relative positional relationship (order) of the localization positions corresponding to the voice signals of each of the call partners is not changed even when the number of call partners is changed, and therefore the voices originating from each of the call partners can be appropriately distinguished, and by changing the localization positions corresponding to each of the voice signals according to the number of call partners after the increase or the decrease, the voices originating from each of the call partners can be made to be easily heard.

### Modifications

In one aspect, the localization position determination unit 107 may perform calculation for determining how to change the localization positions corresponding to the voice signals of each of the call partners itself. Alternatively, the calculation itself may be performed in the server 110 connected to the call terminal 1 via a network, the call terminal 1 may receive the calculation results by the server 110, and the localization position determination unit 107 may change the localization positions corresponding to the voice signals of each of the call partners, based on the received results.

In the above example, as illustrated in Step S101 and Step S102 of FIG. 7, the call participant count increase/decrease detection unit 106 determines whether or not the number of call partners is increased or decreased by acquiring the number of call partners from the call participant count acquisition unit 101. However, the present embodiment is not limited to this. In the present embodiment, the determination of the increase or the decrease of the number of call partners may be performed with another method. For example, only when the user 201 participates in a call, the call participant count increase/decrease detection unit 106 may acquire the number of call partners from the call participant count acquisition unit 101 as illustrated in Step S101 of FIG. 7, and may determine the increase or the decrease of the number of call partners, based on a log-in or log-off event of the call partner regarding the call.

### Second Embodiment

In the call terminal 1 according to the first embodiment described above, the localization position determination unit 107 changes the localization positions so as not to change the relative positional relationship of the localization positions corresponding to the voice signal of each of the call partners before the call participant count is increased or decreased. Note that, as does a localization position determination unit 1070 in a control unit 1030 of a call terminal 10 according to a second embodiment, the localization position determination unit may change the localization positions corresponding to the voice signals of the call partners so as not to change the absolute positions of each of the call partners before the call participant count is increased or decreased.

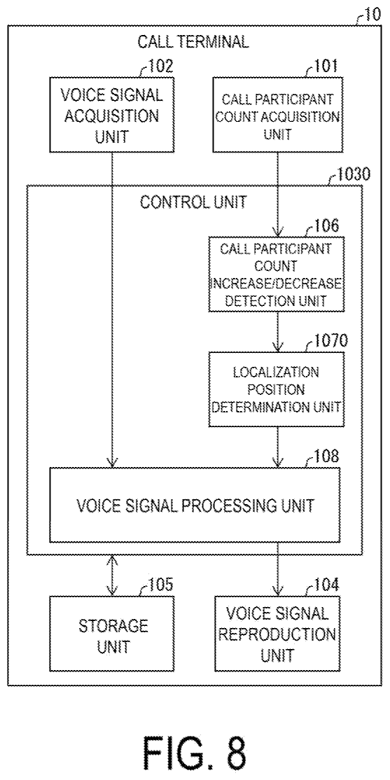

The call terminal 10 according to the second embodiment will be described below with reference to FIGS. 8 to 10. Note that, for the sake of convenience of description, members having the same functions as the members described in the first embodiment are denoted by the same reference signs, and the description thereof will be omitted.

### Call Terminal 10

FIG. 8 is a block diagram illustrating a principal configuration of the call terminal 10 according to the second embodiment.

As illustrated in FIG. 8, the call terminal 10 includes a control unit 1030 instead of the control unit 103 of the call terminal 1 according to the first embodiment. Except for this configuration, the call terminal 10 has the same configuration as the call terminal 1 according to the first embodiment.

### Control Unit 1030

As illustrated in FIG. 8, the control unit 1030 includes a localization position determination unit 1070 instead of the localization position determination unit 107 according to the first embodiment. Except for this configuration, the control unit 1030 has the same configuration as the control unit 103 according to the first embodiment.

### Localization Position Determination Unit 1070

Based on the increase or the decrease of the call participant count, the localization position determination unit 1070 changes the localization positions corresponding to the voice signals of the call partners so as not to change the absolute positions of each of the call partners before the call participant count is increased or decreased.

In a case where the call partner is added, the localization position determination unit 1070 determines the localization position corresponding to the voice signal of the added call partner according to the localization positions corresponding to the voice signals of the call partners before the addition while maintaining the localization positions corresponding to the voice signals of the call partners before the addition. In one aspect, the localization position determination unit 1070 identifies an available position not filled by the localization positions corresponding to the voice signals of the call partners before the addition, and determines the identified available position as the localization position corresponding to the voice signal of the added call partner.

In a case where the call partner is eliminated, the localization position determination unit 1070 maintains the localization positions corresponding to the voice signals of the remaining call partners. For example, in a case where the number of call partners is reduced such as in a case where there is a call partner who ends the call, the localization position determination unit 1070 changes the state of the localization position corresponding to the voice signal of the call partner to be eliminated to an available state. Here, the available state refers to a state in which the voice corresponding to the voice signal of the call partner is not assigned.

Note that the localization position determination unit 1070 may determine the upper limit for the number of call partners and candidate positions for the localization position in advance. In this case, in a case where the number of call partners exceeds the upper limit, even in a case where the call partner is increased, the localization position determination unit 1070 does not determine the localization position corresponding to the voice signal of the increased call partner and does not let the call partner participate in the call. The localization position determination unit 1070 selects the localization positions corresponding to the voice signals of each of the call partners only from the candidate positions for the localization position determined in advance. Note that the present invention is not limited to this. The localization position determination unit 1070 need not set the upper limit for the number of call partners and may determine the localization position at any positions.

### Change of Localization Position

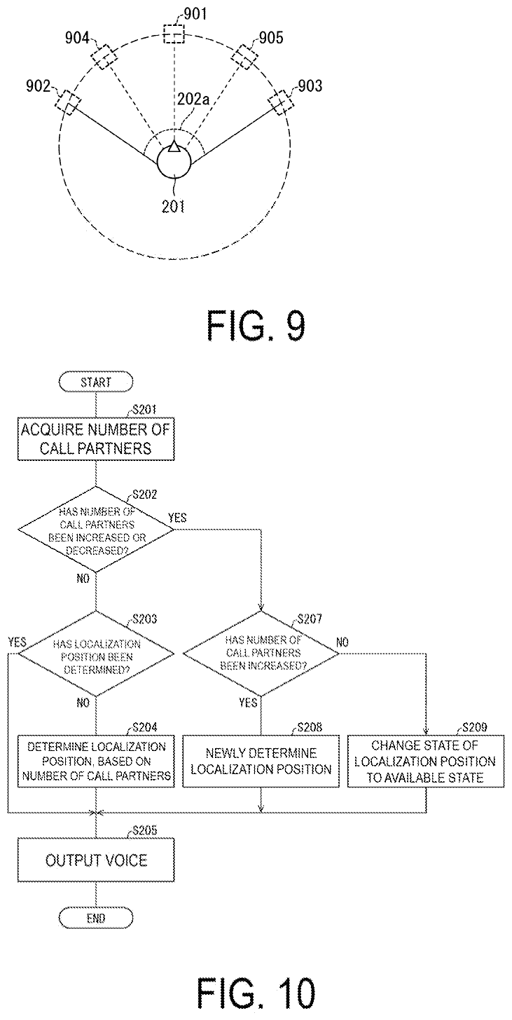

The change method of the localization positions corresponding to the voice signals of the call partners by the localization position determination unit 1070 in a case where the number of call partners is increased or decreased will be described below with reference to FIG. 9. FIG. 9 is a diagram illustrating an example of the localization positions corresponding to the voice signals of the call partners according to the second embodiment. The following will describe a case in which the localization position determination unit 1070 sets the upper limit for the call participant count to be five, and determines localization positions 901 to 905 illustrated in FIG. 9 as the candidate positions for the localization position determined in advance.

Here, the localization positions 901 to 905 are assigned identifiers 1 to 5, respectively. In one example, call partner information related to each call partner has a structure illustrated in the following table 1. Specifically, the call partner information includes an identifier of the call partner for uniquely identifying each call partner, and an identifier of the localization position indicating the localization position corresponding to the voice signal of the call partner. Note that, in a case where the localization position is not determined yet, the identifier of the localization position may be an identifier indicating that the localization position has not been determined yet.

TABLE 1

IDENTIFIER OF CALL PARTNER
IDENTIFIER OF LOCALIZATION POSITION

In a case where the number of call partners is increased or decreased, the localization position determination unit 1070 receives, from the call participant count increase/decrease detection unit 106, the call partner information of each call partner as well as a notification indicating that the number of call partners has increased or decreased. The localization position determination unit 1070 can operate the localization positions corresponding to the voice signals of each of the call partners by processing the call partner information.

In FIG. 9, for example, it is assumed that the call partner assigned identifier 1 corresponding to the localization position 901 ends the call, and the number of call partners is decreased by one. In this case, the localization position determination unit 1070 changes the state of the localization position 901 to the available state, and maintains the states of the localization positions corresponding to the voice signals of the rest of the call partners. It is assumed that, in a state in which the call partners corresponding to the localization positions 901 and 903 participate in the call, one call partner newly participates in the call and the number of call partners is increased by one. In this case, the localization position determination unit 1070 determines the localization position corresponding to the identifier having the smallest value out of the numbers of the identifiers corresponding to the localization positions currently in the available state as the localization position corresponding to the voice signal of the call partner who has newly participated. Specifically, the localization position determination unit 1070 determines the localization position 902 corresponding to identifier 2 having the smallest value out of identifiers 2, 4, and 5 corresponding to the localization positions 902, 904, and 905 currently in the available state as the localization position corresponding to the voice signal of the call partner who has newly participated.

As described above, also by determining the localization positions corresponding to the voice signals of the call partners so as not to change the absolute positions of each of the call partners before the call participant count is increased or decreased, the change of the positional relationship of the localization positions corresponding to the voice signals of each of the call partners can be reduced to the minimum necessary. This configuration can prevent a significant alteration in the positional relationship of the localization positions corresponding to the voice signals of each of the call partners that the user has recognized before the call participant count is increased or decreased. As a result, the user can be prevented from incorrectly recognizing the call partners. Therefore, even when the number of call partners is increased or decreased, the voices corresponding to the voice signals of each of the call partners can be output so that the user can more easily hear and distinguish the voices. By determining the upper limit for the call participant count and the localization positions in advance by using the identifiers of the call partners or the like, the localization positions corresponding to the voice signals of the call partners can be more appropriately changed so as not to change the absolute positions of each of the call partners before the call participant count is increased or decreased.

Note that, in the above example, the localization position determination unit 1070 determines the localization position corresponding to the identifier having the smallest value out of the numbers of the identifiers corresponding to the localization positions currently in the available state as the localization position corresponding to the voice signal of the call partner who has newly participated. Note that, in the present embodiment, the localization position determination unit 1070 may determine the localization position corresponding to any identifier as the localization position corresponding to the voice signal of the call partner who has newly participated in so far as the localization positions corresponding to the voice signals of the call partners can be changed so as not to change the absolute positions of each of the call partners before the call participant count is increased or decreased.

### Control Processing of Call Terminal 10

Next, with reference to FIG. 10, the procedure of the control processing of the call terminal 10 (control method of the call terminal) according to the present embodiment will be described. FIG. 10 is a flowchart illustrating an example of the procedure of the control processing of the call terminal 10 according to the second embodiment.

Here, Step S201 to Step S205 are the same as Step S101 to Step S105 of the control processing of the call terminal 1 according to the first embodiment, and thus description thereof will be omitted.

In Step S206, the localization position determination unit 1070 acquires the call partner information from the call participant count increase/decrease detection unit 106.

In Step S207, in a case where the call participant count is increased (YES in Step S207), that is, in a case where there is a call partner who newly participates in the call, the processing proceeds to Step S208. In a case where the call participant count is changed without being increased (NO in Step S207), that is, in a case where there is a call partner who ends the call and the call participant count is reduced, the processing proceeds to Step S209.

In Step S208, the localization position determination unit 1070 determines the localization position corresponding to the identifier corresponding to the call partner who has newly participated out of the localization positions currently in the available state as the localization position corresponding to the voice signal of the call partner who has newly participated (localization position change step).

In Step S209, the localization position determination unit 1070 changes the state of the localization position corresponding to the voice signal of the call partner who has ended the call to the available state (localization position change step).

### Third Embodiment

The function of the call terminal 1 according to the first embodiment may be implemented by a call system 100 according to a third embodiment.

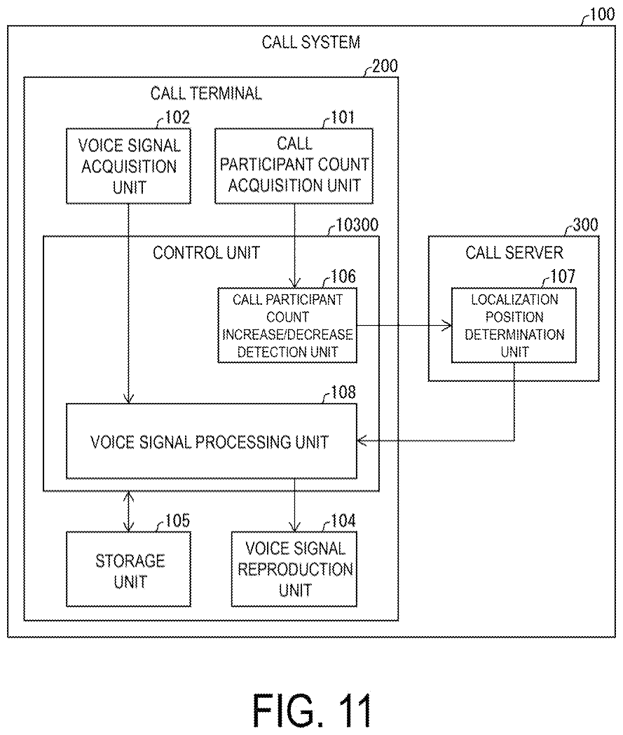

The call system 100 according to the third embodiment will be described below with reference to FIG. 11. Note that, for the sake of convenience of description, members having the same functions as the members described in the embodiments described above are denoted by the same reference signs, and the description thereof will be omitted.

### Call System 100

FIG. 11 is a block diagram illustrating a principal configuration of the call system 100 according to the third embodiment. The call system 100 includes a call terminal 200 and a call server 300. The call server 300 includes the localization position determination unit 107.

In this manner, in the call system 100, the call terminal 200 includes a control unit 10300 not including the localization position determination unit 107 instead of the control unit 103 including the localization position determination unit 107 in the call terminal 1 according to the first embodiment, and the call system 100 further includes the call server 300 including the localization position determination unit 107.

In the call system 100, the call terminal 200 receives the voice signals of each of one or more call partners, and the call system 100 includes the localization position determination unit 107 that, in a case where the call partner is added for the call terminal 200, determines the localization position corresponding to the voice signal of the added call partner received by the call terminal 200 so as not to overlap with the localization positions corresponding to the voice signals of other call partners, and the call terminal 200 outputs the voices corresponding to each of the received voice signals so that the voices are localized at the localization positions determined by the localization position determination unit 107.

More specifically, as illustrated in FIG. 11, in the call system 100, the call participant count acquisition unit 101 of the call terminal 200 acquires the number of call partners, and the voice signal acquisition unit 102 acquires the voice signals of each of the call partners. The call participant count increase/decrease detection unit 106 of the call terminal 200 acquires the information of the call participant count from the call participant count acquisition unit 101, and detects whether the call participant count has increased or decreased from the previously acquired call participant count. In a case where the call partner is added or eliminated, the localization position determination unit 107 of the call server 300 determines the localization position corresponding to the voice signal of the call partner who has been added or eliminated so as not to overlap with the localization positions corresponding to the voice signals of other call partners, based on detection results of the call participant count increase/decrease detection unit 106 of the call terminal 200. The voice signal processing unit 108 of the call terminal 200 configures the voices to be reproduced from the voice signal reproduction unit 104, based on the voice signals of each of the call partners obtained from the voice signal acquisition unit 102 of the call terminal 200 and the localization positions corresponding to each of the voice signals obtained from the localization position determination unit 107 of the call server 300. The voice signal reproduction unit 104 of the call terminal 200 outputs each of the voices corresponding to each of the voice signals so that the voices are localized at the localization positions determined by the localization position determination unit 107 of the call server 300.

In this manner, the call system 100 functions in a manner similar to the call terminal 1 according to the first embodiment as a whole. According to the call system 100, with the call server 300 performing the processing of the localization position determination unit 107, the processing amount of the call terminal 200 can be reduced.

Note that the above example describes a case in which, in the call system 100, the call server 300 includes the localization position determination unit 107 instead of the call terminal 200. However, the present embodiment is not limited to this. In the present embodiment, it is only necessary that the call terminal 200 include at least the voice signal reproduction unit 104, and the call server 300 may include other members instead of the call terminal 200. For example, the call server 300 may include the storage unit 105, the localization position determination unit 107, and the control unit 10300, that is, the storage unit 105 and the control unit 103 of FIG. 1, instead of the call terminal 200, and the call server 300 may further include the call participant count acquisition unit 101 and the voice signal acquisition unit 102 in addition to the control unit 103 and the storage unit 105 instead of the call terminal 200. In this case as well, the call system 100 can function in a manner similar to the call terminal 1 according to the first embodiment as a whole while reducing the processing amount of the call terminal 200.

### Implementation Example by Software

Control blocks of the call terminal 1 or 10 (in particular, the call participant count increase/decrease detection unit 106, the localization position determination unit 107 or 1070, and the voice signal reproduction unit 104) may be implemented by logic circuits (hardware) formed in integrated circuits (IC chips) and the like, or may be implemented by software.

In the latter case, the call terminal 1 or 10 is provided with a computer that executes commands of a call program, which is software for implementing each function. The stated computer includes at least one processor (control apparatus), for example, and includes at least one computer-readable recording medium having stored the call program therein. In the computer, the processor reads out the call program from the recording medium and executes the call program, thereby accomplishing the object of the present embodiment. For example, a Central Processing Unit (CPU) may be used as the processor. As the recording medium, a “non-transitory tangible medium” such as a tape, a disk, a card, a semiconductor memory, and a programmable logic circuit may be used in addition to a Read Only Memory (ROM). A Random Access Memory (RAM) on which the call program is loaded, or the like may be further provided. The program may be supplied to the computer via any transmission medium (communication network, broadcast wave, or the like) capable of transmitting the call program. Note that an aspect of the present invention may be implemented in a form of data signal embedded in a carrier wave, which is embodied by electronic transmission of the call program.

1. A call terminal comprising:
a reception unit configured to receive a voice signal of each of one or more call partners;
a localization position determination unit configured to, in a case where one of the one or more call partners is added, determine a localization position corresponding to the voice signal of the added one of the one or more call partners not to overlap with a localization position corresponding to the voice signal of another one of the one or more call partners;
a voice output unit configured to output voice corresponding to each voice signal in manner that the voice is localized at the localization position determined by the localization position determination unit; and
a range input unit configured to receive input of a localizable range, wherein
the localization position determination unit determines the localization position in the localizable range.

2. A call terminal comprising:
a reception unit configured to receive a voice signal of each of one or more call partners;
a localization position determination unit configured to, in a case where one of the one or more call partners is eliminated, determine a localization position corresponding to the voice signal of the eliminated one of the one or more call partners not to overlap with the localization position corresponding to the voice signal of another one of the one or more call partners;
a voice output unit configured to output voice corresponding to each voice signal in manner that the voice is localized at the localization position determined by the localization position determination unit; and
a range input unit configured to receive input of a localizable range, wherein
the localization position determination unit determines the localization position in the localizable range.

3. The call terminal according to claim 1,
wherein in a case where the one of the one or more call partners is added, the localization position determination unit changes the localization position corresponding to each voice signal according to the number of the one or more call partners after the addition while maintaining order of the localization positions corresponding to the voice signal of the one or more call partners before the addition.

4. The call terminal according to claim 1,
wherein in a case where the one of the one or more call partners is eliminated, the localization position determination unit changes the localization position corresponding to each voice signal according to the number of the one or more call partners after the elimination while maintaining order of the localization positions corresponding to the voice signal of remaining call partners among the one or more call partners.

5. The call terminal according to claim 3,
wherein the localization position determination unit changes the localization position corresponding to each voice signal in manner that intervals between adjacent ones of the localization positions are uniform.

6. The call terminal according to claim 1,
wherein in a case where the one of the one or more call partners is added, the localization position determination unit determines the localization position corresponding to the voice signal of the added one of the one or more call partners according to the localization position corresponding to of the voice signal of the one or more call partners before the addition while maintaining the localization position corresponding to the voice signal of the one or more call partners before the addition.

7. The call terminal according to claim 1,
wherein in a case where the one of the one or more call partners is eliminated, the localization position determination unit maintains the localization position corresponding to the voice signal of a remaining one of the one or more call partners.

8. A call system comprising:
a call terminal; and
a call server,
wherein the call terminal receives a voice signal of each of one or more call partners,
the call server comprises
a localization position determination unit configured to, in a case where one of the one or more call partners is added for the call terminal, determine a localization position corresponding to the voice signal of the added one of the one or more call partners received by the call terminal not to overlap with the localization position corresponding to the voice signal of another one of the one or more call partners, and
a range input unit configured to receive input of a localizable range, wherein
the localization position determination unit determines the localization position in the localizable range, and
the call terminal outputs voice corresponding to each received voice signal in manner that the voice is localized at the localization position determined by the localization position determination unit.

9. A control method of a call terminal, the control method comprising:
a reception step of using the call terminal to receive a voice signal of each of one or more call partners;
a range input step of receiving input of a localizable range;
a localization position determination step of, in a case where one of the one or more call partners is added, determining a localization position corresponding to the voice signal of the added one of the one or more call partners not to overlap with a localization position corresponding to the voice signal of another one of the one or more call partners; and
a voice output step of using the call terminal to output voice corresponding to each voice signal in manner that the voice is localized at the localization position determined in the localization position determination step, wherein
the localization position determination step determines the localization position in the localizable range.

10. A non-transitory computer-readable recording medium recording a call program for causing a computer to function as the call terminal according to claim 1,
wherein the call program is a call program for causing the computer to function as the localization position determination unit.

11. (canceled)
